(19) United States
(12) Patent Application Publication
(10) Pub. No.: US 2007/0007099 A1
(43) Pub. Date: Jan. 11, 2007

(54) Motor vehicle transmission with several shifting elements and a hill-holder on the transmission side as well as a procedure to control this transmission

(76) Inventors: Armin Gierling, Langenargen (DE); Ruben Cuppers, Tettnang (DE)

Correspondence Address: DAVIS & BUJOLD, P.L.L.C., 112 PLEASANT STREET, CONCORD, NH, 03301, US

(21) Appl. No.: 11/455,989

(22) Filed: Jun. 20, 2006

(30) Foreign Application Priority Data
Jul. 9, 2005 (DE) 10 2005 032 202.6

(51) Int. Cl. F16H 63/48

(52) U.S. Cl. 192/219.1

(57) ABSTRACT

A vehicle transmission with shifting elements and a transmission side hill-holder as well as a procedure to control this transmission, with at least two shifting elements of the transmission are the hill-holder, that a braking moment arises at the output of the transmission and acts against a rolling away of the vehicle or the output of the transmission is blocked, whereby the flow of power between a drive motor of the vehicle and a shifting element of the transmission located in the power flow can be partially or completely interrupted during the activation of the hill-holder. If it is recognized that the driver wants to leave or is leaving the vehicle with the motor running and a gear of the transmission simultaneously engaged in a drive position and a simultaneously activated transmission side hill-holder, then the previously activated transmission side hill-holder is automatically deactivated.

This application claims priority from German Application Serial No. 10 2005 032 202.6 filed Jul. 9, 2005.

### FIELD OF THE INVENTION

The invention involves a motor vehicle transmission with several shifting elements and a hill-holder on the transmission side, as well as a procedure to control this transmission, whereby depending on the driving situation at least two shifting elements of the transmission can be so electronically triggered as a hill-holder, that a braking moment arises at the output of the transmission preventing a rolling away of the vehicle or the output of the transmission is blocked, whereby the flow of power between the drive motor of the vehicle and a shifting element of the transmission located in the power flow can be partially or even totally interrupted, when the hill-holder is activated.

Vehicle transmissions with a transmission side hill-holder function for a fixing or blocking of the transmission output, as needed, are known to a great extent in current practice. It can thus be shown, for example, that the transmission output is arrested by closing a brake inside the transmission to the transmission housing, or that the transmission output is blocked by a simultaneous setting of two gears of the transmission, or that the rotation of the transmission output can be stopped by an override clutch supported in the transmission housing or a brake placed in the power flow parallel to the override clutch.

Thus a control device for an automatic transmission of a vehicle is known from EP 0 781 946 B1 in which a start-up clutch of the automatic transmission is automatically disengaged or opened, when the vehicle is stopped in a forward drive area, thus a vehicle stoppage is recognized with a simultaneously set forward drive position of a transmission operating device. At the same time a so-called hill-holder formed by a shifting element of the automatic transmission is engaged or closed, which thereby precludes an output shaft of the automatic transmission turning because of the disengaging of the start-up clutch in one direction opposite the selected drive direction. In the process the transfer capability of the start-up clutch during the opening is greatly reduced, in that the transfer capability of the hill-holder brake is increased; conversely the transfer capability of the start-up clutch during the closing is greatly increased, in that the transfer capability of the hill-holder brake is reduced. The transfer capability of the hill-holder brake is changed depending on a relationship between the initial and final rotational speeds of a torque converter which is positioned in the power flow between the motor of the vehicle and the automatic transmission. This rotational speed relationship in turn depends on the transfer capability of the start-up clutch.

Known from DE 102 39 392 A1 of the Applicant is a procedure to control a customary vehicle automatic transmission with a torque converter and several shifting elements in which a backward-rolling blocker is envisioned, that by way of a specific engaging of shifting elements in a combination, which does not correspond to any normal gear of the transmission, a braking moment is produced inside the transmission on the drive shaft of the transmission that opposes any backward rolling of the vehicle in the direction opposite to the selected drive direction. The backward rolling blocker function is effectively coupled with a slippage control of a clutch located in the power flow and activating upon the starting of the vehicle in such a way, that an engine speed suitable for starting is set in conjunction with the properties of a hydro-dynamic torque converter on the drive motor placed in the power flow between the drive motor and the automatic transmission.

Usually a hill-holder on the transmission side can only be activated when a lack of vehicle motion (the vehicle is at least almost stopped) is recognized with a selected drive gear (in an automatic transmission usually the gear selector lever is set in “D”) and simultaneously the engine of the vehicle is in neutral. With an activated hill-holder the frictional connection between the drive motor and the transmission can be, depending on the underlying concept, completely interrupted, diminished or partially interrupted or also be completely maintained. In the first case the start-up clutch of the transmission is opened with an activated hill-holder and in the second case is regulated for slippage. The third case requires the placement of a hydrodynamic torque converter or a hydrodynamic clutch between the drive motor and the start-up or input clutch of the transmission; correspondingly in the third case a slippage arises in the hydrodynamic start-up element with an activated hill-holder.

Other criteria upon whose appearance or attainment a previously activated transmission side hill-holder is automatically ended, are, for example, removal from the gear selection setting, “D”, an activation of a foot pedal of the vehicle, an increase of the torque of engine speed of the drive motor to a value above a predetermined threshold value, for example, exceeding a pre-defined transmission temperature as protection of the transmission against overheating.

If a transmission side hill-holder of the type previously described is present in a vehicle, there can arise operating conditions critical for safety, if the driver of the vehicle leaves the vehicle with a previously set hill-holder. Namely if one of the mentioned criteria to automatically end the hill-holder function is satisfied, when the driver is no longer in the vehicle, the vehicle will abruptly and unintentionally roll, depending on the actual driving situation present or the actual environmental condition present.

A sudden change of the gear selector position or foot pedal position presumes either a suddenly appearing error or an active operation of the gear selector or the foot pedal. Such an activation of the selector lever and/or foot pedal can unintentionally occur, for example, due to a child in the vehicle or a household pet in the vehicle. A sudden increase of the engine speed and motor torque can occur because of the motor control itself, for example, the automatic activation of an air conditioner compressor or another heavy electrical consumer. Exceeding a critical transmission temperature can, for example, be caused by too long an operation with a clutch slippage, if applicable in conjunction with a high outdoor temperature.

### BACKGROUND OF THE INVENTION

This invention has the basic task of creating a vehicle transmission with several shifting elements and a transmission side hill-holder of the type named at the outset as well as a procedure to control this transmission in which the named operating conditions critical for safety—in particular a release of the previously activated hill-holder which is critical for safety—can be avoided. Envisioned thereby as a transmission side hill-holder is, that depending on the driving situation at least two shifting elements of the transmission can be so controlled, that a braking moment arises at the output of the transmission acting to prevent a rolling away of the vehicle or the output of the transmission is blocked, whereby the flow of power between the drive motor of the vehicle and a shifting element of the transmission in the power flow during activation of the hill-holder can be partially or completely interrupted.

### DETAILED DESCRIPTION OF THE INVENTION

The invention proceeds from a vehicle transmission with several shifting elements and a transmission side hill-holder, whereby depending on the driving situation at least two shifting elements of the transmission are so controlled as a hill-holder, that a braking moment arises at the output of the transmission and acts against a rolling away of the vehicle or the output of the transmission is blocked, whereby the flow of power between a drive motor of the vehicle and a shifting element of the transmission located in the power flow can be partially or completely interrupted during the activation of the hill-holder.

The first four solutions of the task according to the invention which are described in the following are based on a monitoring of whether the driver wants to leave or is leaving the vehicle with a running motor and a simultaneously set drive condition or gear selection (“selector lever”) of the transmission and a simultaneously activated transmission side hill-holder.

Thus in the first solution of the task according to the invention a procedure to control an appropriate vehicle transmission with several shifting elements and a transmission hill-holder is achieved by way of controlling at least two of these shifting elements in which the previously activated transmission side hill-holder is automatically deactivated, if there is recognition that a driver wants to leave or is leaving a vehicle with a running motor and a simultaneously set drive position of the gear selection device of the transmission and a simultaneously activated transmission side hill-holder.

As a result, the transmission is again brought to its normal operating mode which usually corresponds to the first gear or the start-up transfer with a power flow between the drive motor and the transmission, so that the vehicle behaves in a manner familiar to the driver, like when starting up. If the transmission is constructed, for example, as a known automatic transmission with a hydrodynamic torque converter as a start-up element, then the vehicle will slowly begin to move after the deactivation of the named transmission side hill-holder because of the creeping tendency of the converter-automatic transmission, as soon as the driver releases the vehicle brake. As a result the driver will rethink his original intention to leave the vehicle with a drive position set on the transmission and take immediate measures to prevent an unintentional starting of the vehicle, for example, by a manual setting of the parking gear of the transmission by an activation of the gear selector level.

It makes sense that an automatic deactivation of the transmission side hill-holder can be combined with a control of an optical and/or acoustic and/or haptic warning device of the vehicle, in order to inform the driver appropriately, in particular that the gear selection device is still in a drive gear and that the vehicle can roll away.

In another variation of this first solution according to the invention it is recommended, that the monitoring performed with an activated transmission side hill-holder of whether the driver wants to leave the vehicle or is leaving the vehicle be combined with a transmission side functional monitoring in such a way that the previously activated transmission side hill-holder can also be automatically activated, when a transmission side error is detected with an activated, transmission side hill-holder.

In the second solution of the task according to the invention, a procedure to control an appropriate vehicle transmission with several shifting elements and a transmission side hill-holder realized by way of a control with at least two of these shifting elements, in which, in addition to the previously activated transmission side hill-holder there is a device redundant to the transmission side hill-holder to arrest the vehicle, when there is recognition that the driver wants to leave or is leaving the vehicle with a running motor and a drive gear of the transmission simultaneously selected by way of the gearshift and a simultaneously activated transmission side hill holder. In the process the device redundant to the transmission side hill-holder to arrest the vehicle can, for example, be a park block of the transmission but also, for example, an operating or parking brake of the vehicle.

In this manner the vehicle is safely held at a stop, even when the driver actually leaves the vehicle with a drive gear still set. Thus any possible conditions critical for safety which can result from an unexpected deactivation of the transmission side hill-holder by the driver are reliably prevented.

Even the activation of an automatic placement in the circuit of a device redundant to the transmission side hill-holder to arrest the vehicle can be combined with an optical and/or acoustic and/or haptic warning device of the vehicle, in order to appropriately inform the driver, in particular that the gear selection device is still in a drive position.

In another variation of this second solution according to the invention it is recommended that the monitoring performed with an activated transmission side hill-holder of whether the driver wants to leave the vehicle or is leaving the vehicle be combined with a transmission side functional monitoring in such a way that the device redundant to the transmission side hill-holder is also automatically activated when a transmission side error is detected with an activated transmission side hill-holder.

In the third solution of the task according to the invention a procedure to control an appropriate vehicle transmission with several shifting elements and a transmission side hill-holder realized with a control of at least two of these shifting elements is recommended in which an optical and/or acoustic and/or haptic warning device of the vehicle is automatically activated, if it is determined, that the driver wants to leave or is leaving the vehicle with a running motor and a simultaneously engaged gear device of the transmission in a drive position and a simultaneously activated transmission side hill-holder.

It makes sense to make this information that the gearshift is still in a drive gear available to the driver in such a manner and intensity that the driver changes his original intention to leave the vehicle with the gear still in a drive position and at least puts the gearshift in the park position.

Finally in the fourth solution of the task according to the invention a procedure to control an appropriate vehicle transmission with several shifting elements and a transmission side hill-holder realized with a control of at least two of these shifting elements is recommended, in which the driver's door of a vehicle is automatically blocked, when it is determined that the driver of the vehicle wants to leave the vehicle with a running motor and a simultaneously engaged gear of the transmission in a drive position and a simultaneously activated transmission side hill-holder.

In this manner the driver is diverted from his original intention of leaving the vehicle with a gearset in a drive position and thus any possible conditions critical for safety are prevented which could occur by way of an unintended deactivation of the transmission block by the driver.

In order not to confuse the driver with an unexpected blocking of the driver's door, it makes sense to also appropriately inform the driver of the blockage of the driver's door by way of an optical and/or acoustic and/or haptic warning device of the vehicle, in particular that the gear device is still set in a drive position.

In all the previously named procedures of the invention the information that the driver wants to leave or is leaving the vehicle is generated by the evaluation of signals from the vehicle. Such signals from the vehicle can, for example, be the opening of a lock of a driver's seat belt, a closed status of the driver's door, especially an electric door contact, seat occupation recognition for the driver's seat, or optical driver recognition.

The fifth and sixth solutions of the task according to the invention are based on a monitoring of the transmission function while the previously described transmission side hill-holder is activated.

In the fifth solution of the task according to the invention a procedure is recommended to control an appropriate vehicle transmission with several shifting elements and a transmission side hill-holder realized with a control of at least two of these shifting elements in which the previously activated transmission side hill-holder is deactivated if a transmission side error is recognized with an activated transmission side hill-holder.

As a result a transmission is brought to an operational condition which corresponds to a transmission side replacement function corresponding to the error or a transmission dry-run operation corresponding to the error which could be independently activated upon the appearance of the error by the transmission side hill-holder and also without a previously activated hill-holder.

In the sixth solution of the task according to the invention a procedure is recommended to control an appropriate vehicle transmission with several shifting elements and a transmission side hill-holder realized with a control of at least two of these shifting elements in which a device redundant to the transmission side hill-holder is automatically activated to arrest the vehicle if a transmission side error is recognized with an activated, transmission side hill-holder. This device redundant to the transmission side hill-holder to arrest the vehicle can, for example, be a parking block of the transmission or an operating or parking brake in the vehicle.

It is thereby reliably ensured that an error in the transmission—for example a failure of control of one of the two shifting elements of the transmission side hill-holder—does not result in a change of the operating behavior of the vehicle that is not expected by the driver, such as sudden rolling.

In all the previously named procedures of the invention it can be provided in an advantageous variant that the automatic deactivation of the transmission side hill-holder or the automatic activation of the second hill-holder or the automatic activation of the device redundant to the transmission side hill-holder to arrest the vehicle occurs immediately when it is recognized that the driver wants to leave or is leaving the vehicle with a running motor and a simultaneously engaged drive position of the gear selector, or when a transmission side error is recognized with an activated transmission side hill-holder.

Naturally all the procedures of the invention can be combined with each other. Thus as a seventh solution of the task according to the invention a vehicle transmission is proposed which exhibits several shifting elements and a transmission side hill-holder realized with a control of at least two of these shifting elements, whereby this control device controls the transmission according to one of the previously named procedures of the invention. In the process the named control device can be simply integrated in an electro-hydraulic transmission control device, which, for example, has advantages with respect to the functional arrangement of the control of the shifting elements involved on the transmission side, hill holder and with regard to the control of the transmission parking block. The named control device can, for example, also be integrated in an electronic motor control electrically connected with the electro-hydraulic transmission control device or an electronic brake control device or other electronic vehicle control devices, whereby the electro-hydraulic transmission control device controls the transmission side hill-holder depending on signals from this control device.

All previously described procedures to control a vehicle transmission according to the invention with several shifting elements and a transmission side hill-holder realized by way of a control of at least two of these shifting elements can in principle be used on any type of transmission construction and are suited, for example, for known automatic transmissions, automatic shifting gears and automatic or automated double clutch transmissions.

1-27. (canceled)

28. A method of controlling a vehicle transmission with several shifting elements and a transmission side hill-holder, the method comprising the steps of:
controlling at least two shifting elements of the transmission acting as the hill-holder depending on a driving situation thereby preventing rolling away of the vehicle by one of engaging a braking moment at an output of the transmission and preventing output of the transmission;
one of partially and completely interrupting a flow of power between a drive motor of the vehicle and a shifting element of the transmission in the power flow during activation of the hill-holder; and
automatically deactivating the previously activated transmission side hill-holder, upon recognition that a driver wants to one of leave or is leaving the vehicle with the drive motor running and a gear of the transmission simultaneously engaged in a drive position and a simultaneously activated, transmission side hill-holder.

29. The method of controlling a vehicle transmission with several shifting elements and a transmission side hill-holder according to claim 28, further comprising the step of automatically activating one or more of an optical, an acoustic and a haptic warning device of the vehicle in addition to automatically deactivating the transmission side, hill holder.

30. The method of controlling a vehicle transmission with several shifting elements and a transmission side hill-holder according to claim 28, further comprising the step of automatically deactivating the previously activated transmission side hill-holder when a transmission-side, error is detected with an activated, transmission side hill-holder.

31. The method of controlling a vehicle transmission with several shifting elements and a transmission side hill-holder according to claim 28, further comprising the step of automatically activating a device redundant to the transmission side hill-holder to arrest the vehicle in addition to the previously activated, transmission side hill-holder upon recognition that the driver one of wants to leave and is leaving the vehicle with the motor running and a gear of the transmission simultaneously engaged in a drive position and a simultaneously activated, transmission side hill-holder.

32. The method of controlling a vehicle transmission with several shifting elements and a transmission side hill-holder according to claim 31, further comprising the step of providing a parking block of the transmission as the device redundant to the transmission side hill-holder to arrest the vehicle.

33. The method of controlling a vehicle transmission with several shifting elements and a transmission side hill-holder according to claim 31, further comprising the step of providing one of an operating or parking brake of the vehicle as the device redundant to the transmission side hill-holder to arrest the vehicle.

34. The method of controlling a vehicle transmission with several shifting elements and a transmission side hill-holder according to claim 31, further comprising the step of activating at least an optical, acoustic and haptic warning device of the vehicle in addition to automatically deactivating the device redundant to the transmission side hill-holder to arrest the vehicle.

35. The method of controlling a vehicle transmission with several shifting elements and a transmission side hill-holder according to claim 31, further comprising the step activating the device redundant to the transmission side hill-holder to arrest the vehicle, when a transmission side error is recognized with an activated, transmission side hill-holder.

36. The method of controlling a vehicle transmission with several shifting elements and a transmission side hill-holder according to claim 28, further comprising the step of automatically activating at least one of an optical, an acoustic and a haptic warning device of the vehicle being upon determination that the driver wants to one of leave or is leaving the vehicle with the motor running and a gear of the transmission simultaneously engaged in a drive position and a simultaneously activated, transmission side hill-holder.

37. The method of controlling a vehicle transmission with several shifting elements and a transmission side hill-holder according to claim 28, further comprising the step automatically locking a driver's door of the vehicle upon determination that the driver wants to one of leave or is leaving the vehicle with the motor running and a gear of the transmission simultaneously engaged in a drive position and a simultaneously activated, transmission side hill-holder.

38. The method of controlling a vehicle transmission with several shifting elements and a transmission side hill-holder according to claim 28, further comprising the step activating at least one of an optical, an acoustic and a haptic warning device of the vehicle also activated to block the driver's door.

39. The method of controlling a vehicle transmission with several shifting elements and a transmission side hill-holder according to claim 37, further comprising the step generating information that the driver wants to one of leave or is leaving the vehicle is generated by the evaluation of signals from the vehicle.

40. The method of controlling a vehicle transmission with several shifting elements and a transmission side hill-holder according to claim 39, further comprising the step of supplying information that the driver of the vehicle wants to one of leave or is leaving the vehicle upon opening of a belt lock of a driver's seat belt.

41. The method of controlling a vehicle transmission with several shifting elements and a transmission side hill-holder according to claim 39, further comprising the step of having a closing status of a driver's door, especially an electric contact for the driver's door, supply information that the driver of the vehicle wants to one of leave or is leaving the vehicle.

42. The method of controlling a vehicle transmission with several shifting elements and a transmission side hill-holder according to claim 39, further comprising the step of supplying information by seat occupation recognition that the driver of the vehicle wants to one of leave or is leaving the vehicle.

43. The method of controlling a vehicle transmission with several shifting elements and a transmission side hill-holder according to claim 39, further comprising the step of supplying information by a driver optical recognition that the driver of the vehicle wants to one of leave or is leaving the vehicle.

44. The method of controlling a vehicle transmission with several shifting elements and a transmission side hill-holder according to claim 28, further comprising the step of automatically deactivating a previously activated transmission side hill-holder when a transmission side error is recognized with an activated transmission side hill-holder.

45. The method of controlling a vehicle transmission with several shifting elements and a transmission side hill-holder according to claim 28, further comprising the step automatically activating a device redundant to the transmission side hill-holder to arrest a vehicle when a transmission side error is recognized with an activated transmission side hill-holder.

46. The method of controlling a vehicle transmission with several shifting elements and a transmission side hill-holder according to claim 45, further comprising the step providing a parking block of the transmission as the device redundant to the transmission side hill-holder to arrest a vehicle.

47. The method of controlling a vehicle transmission with several shifting elements and a transmission side hill-holder according to claim 45, further comprising the step providing one of an operating or a parking brake of the vehicle as the device redundant to the transmission side hill-holder to arrest a vehicle.

48. The method of controlling a vehicle transmission with several shifting elements and a transmission side hill-holder according to claim 28, further comprising the step of automatically deactivating at least one of the transmission side hill-holder, the automatic activation of a second hill-holder and the automatic activation of the device redundant to the transmission side hill-holder to arrest the vehicle following immediately, upon recognition that the driver wants to one of leave or is leaving the vehicle with the motor running and a gear of the transmission simultaneously engaged in a drive position and one of a simultaneously activated transmission side hill-holder or a transmission side error is recognized with an activated transmission side hill-holder.

49. A vehicle transmission with several shifting elements and a transmission side hill-holder, the vehicle transmission comprising:
a means of a controlling at least two of shifting elements with a control device to control the transmission according to the method comprising the steps of:
controlling at least two shifting elements of the transmission acting as the hill-holder depending on a driving situation thereby preventing rolling away of the vehicle by one of engaging a braking moment at an output of the transmission and preventing the output of the transmission;
one of partially and completely interrupting a flow of power between a drive motor of the vehicle and a shifting element of the transmission in the power flow during activation of the hill-holder; and
automatically deactivating the previously activated transmission side hill-holder, upon recognition that a driver wants to one of leave or is leaving the vehicle with the drive motor running and a gear of the transmission simultaneously engaged in a drive position and a simultaneously activated, transmission side hill-holder.

50. The vehicle transmission with several shifting elements and a transmission side hill-holder according to claim 49, wherein the electronic braking control device is integrated into an electro-hydraulic transmission control device.

51. The vehicle transmission with several shifting elements and a transmission side hill-holder according to claim 49, wherein the control device is integrated into one of the electronic braking control device or in an electronic vehicle control device which is electrically connected with an electro-hydraulic transmission control device, such that the electro-hydraulic transmission control device controls the transmission side hill-holder depending on signals from the control device.

52. The vehicle transmission with several shifting elements and a transmission side hill-holder according to claim 49, wherein the transmission is an automatic transmission.

53. The vehicle transmission with several shifting elements and a transmission side hill-holder according to claim 49, wherein the transmission is an automatic shifting transmission.

54. The vehicle transmission with several shifting elements and a transmission side hill-holder according to claim 49, wherein the transmission is one of an automatic or automated double clutch transmission.
